(19) United States
(12) Patent Application Publication
(10) Pub. No.: US 2015/0339272 A1
(43) Pub. Date: Nov. 26, 2015

(54) PROJECT-DATA CREATION APPARATUS

(71) Applicants: Tomohiro IWAKI, Tokyo (JP); MITSUBISHI eLECTRIC CORPORATION, Tokyo (JP)

(72) Inventor: Tomohiro IWAKI, Tokyo (JP)

(73) Assignee: Mitsubishi Electric Corporation, Tokyo (JP)

(21) Appl. No.: 14/759,574

(22) PCT Filed: Jan. 8, 2013
(86) PCT No.: PCT/JP2013/050083

§ 371 Date: Jul. 7, 2015

(51) Int. Cl. G06F 17/21; G06F 17/30

(52) U.S. Cl. CPC G06F 17/212; G06F 17/30011

(57) ABSTRACT

A project-data creation apparatus includes a project-data decomposing unit decomposing project data being created into resources, a resource-data managing unit generating index information for resource management and causing a data storing unit to store actual data of resources, a screen configuring unit creating blocks in the project data being created and generating screen configuration information defining a transition relation between screens included in the project data being created and the blocks, an import-data decomposing unit decomposing data to be imported into blocks into resources, a consistency checking unit determining whether redundancy among resources occurs when data is imported, and an import-data integrating unit that, when redundancy among resources does not occur, rebuilds the screen configuration information and causes the data storing unit to store the actual data of the resources of the imported data.

### FIELD

The present invention relates to a project-data creation apparatus.

### BACKGROUND

In creating project data for a programmable display, there is known a method of defining a transition relation among screens by creating a screen transition diagram on an editor (see Patent Literature 1). In the creation of the project data for the programmable display, when new project data is created, data is sometimes diverted from previously-created project data, template data, sample data, and the like rather than creating the project data from the beginning.

### CITATION LIST

### Patent Literature

Patent Literature 1: WO 99/27438

### SUMMARY

### Technical Problem

In the conventional project-data creation apparatus, when project data is created by diverting a plurality of pieces of existing data or the like, for example, if a part of three pieces of data, i.e., project data B, C, and D, is diverted to create project data A, it is necessary to perform works for, for example, starting a plurality of kinds of drawing software (e.g., four kinds of drawing software A, B, C, and D) and manually copying the project data B, C, and D to the project data A or sequentially capturing the project data B, the project data C, and the project data D using an “other project reading” function of the project data A. It is necessary to perform these works while paying attention to, for example, the redundancy among resources. This is extremely time-consuming and complicated work. In particular, when there are a lot of screens to be diverted, the works take a long time.

The present invention has been achieved in view of the above and it is an object of the present invention to obtain a project-data creation apparatus capable of diverting data such as previously-created project data, templates, and sample data, including a transition relation among screens.

### Solution to Problem

In order to solve the above problems and achieve the object, an aspect of the present invention is a project-data creation apparatus that includes a data storing unit and an external storage medium that store information in a nonvolatile manner, and that creates project data including a plurality of screens, including: a project-data decomposing unit that decomposes project data being created into resources, which are management units; a resource managing unit that generates index information for managing resources decomposed by the project-data decomposing unit and causes the data storing unit to store actual data of resources; a screen configuring unit that creates, in the project data being created, blocks each for grouping one or more resources and generates screen configuration information defining a transition relation between screens included in the project data being created and the blocks; an import-data decomposing unit that reads out, from the external storage medium, data to be imported into the blocks and decomposes the data into resources; a consistency checking unit that determines whether resource redundancy occurs among data to be imported into the blocks and between the project data being created and the data to be imported into the blocks; and an import-data integrating unit that, when the consistency checking unit determines that resource redundancy does not occur, integrates the data imported into the blocks with the project data being created by rebuilding the screen configuration information on a basis of a transition relation among screens included in the data imported into the blocks and causing the data storing unit to store actual data of resources of imported data.

### Advantageous Effects of Invention

The project-data creation apparatus according to the present invention attains an effect that it is possible to easily create project data by partially diverting previously-created screen data, templates, sample data, and the like.

### BRIEF DESCRIPTION OF DRAWINGS

FIG. 1 is a diagram showing the configuration of an embodiment of a project-data creation apparatus according to the present invention.

FIG. 2 is a flowchart illustrating the flow of import processing performed by a project-data creation apparatus according to the embodiment.

FIG. 3 is a diagram showing an example of a screen transition diagram.

FIG. 4 is a diagram showing an example of screen configuration information.

FIG. 5 is a diagram showing an example of a screen tree.

FIG. 6 is a diagram showing an example of a screen transition diagram after block definition.

FIG. 7 is a diagram showing an example of screen configuration information after block definition.

FIG. 8 is a diagram showing the concept of an operation for designating data to be imported into each block.

FIG. 9A is a diagram showing an example of block information.

FIG. 9B is a diagram showing an example of block information.

FIG. 9C is a diagram showing an example of block information.

FIG. 10 is a diagram showing an example of belonging block information.

FIG. 11 is a diagram showing an example of a screen transition diagram after import processing.

FIG. 12 is a diagram showing an example of a screen transition diagram after expansion of blocks.

FIG. 13 is a diagram showing an example of screen configuration information after expansion of blocks.

FIG. 14 is a conceptual diagram in which data is stored as one file for each block.

FIG. 15 is a diagram showing a screen transition diagram in which another block (a block E) is defined in or imported into a block A after completion of import processing.

FIG. 16 is a diagram showing an example of screen configuration information after definition or import of the block E.

FIG. 17A is a diagram showing an example of block information.

FIG. 17B is a diagram showing an example of block information.

FIG. 17C is a diagram showing an example of block information.

FIG. 17D is a diagram showing an example of block information.

FIG. 18 is a diagram showing belonging block information after definition or import of the block E.

FIG. 19 is a diagram showing a screen transition diagram in which blocks A to C and E are expanded.

FIG. 20 is a diagram showing a screen transition diagram in which a screen with a screen number 203 and a screen with a screen number 313 are defined as a block D.

FIG. 21 is a diagram showing screen configuration information in which the screen with the screen number 203 and the screen with the screen number 313 are defined as the block D.

FIG. 22A is a diagram showing an example of block information.

FIG. 22B is a diagram showing an example of block information.

FIG. 22C is a diagram showing an example of block information.

FIG. 22D is a diagram showing an example of block information.

FIG. 22E is a diagram showing an example of block information.

FIG. 23 is a diagram showing belonging block information in which the screen with the screen number 203 and the screen with the screen number 313 are defined as the block D.

FIG. 24 is a diagram showing an example of a screen-transition-diagram creation screen.

FIG. 25 is a diagram showing a screen-transition-diagram creation screen in which a warning to the effect that there is redundancy among resources is displayed in a resource-setting display field.

FIG. 26 is a diagram showing an example of a redundant-content check screen.

FIG. 27 is a diagram showing an example of an import-detail setting screen.

FIG. 28 is a diagram showing an example of an import-detail setting screen after a change of resources to be imported.

FIG. 29 is a diagram showing a screen-transition-diagram creation screen after elimination of redundancy among the resources.

FIG. 30 is a diagram showing a screen-transition-diagram creation screen after completion of import.

### DESCRIPTION OF EMBODIMENTS

Exemplary embodiments of a project-data creation apparatus according to the present invention are explained in detail below with reference to the drawings. Note that the present invention is not limited by the embodiments.

### Embodiment

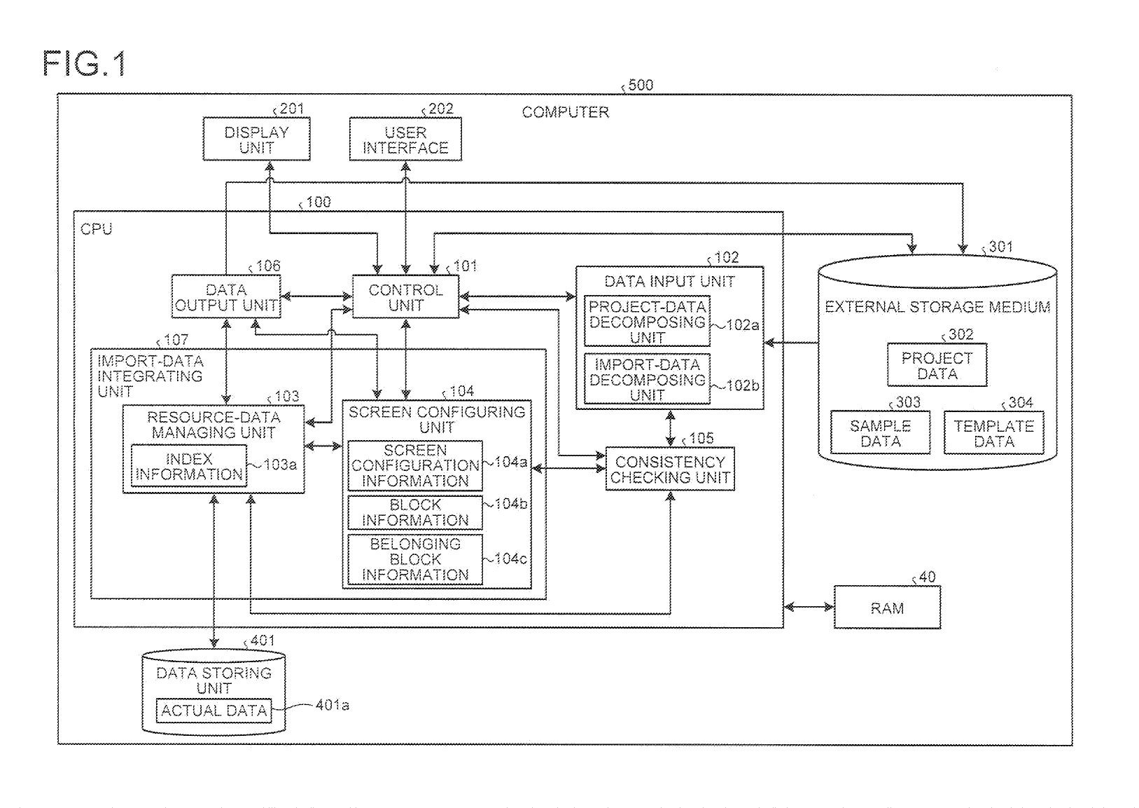

FIG. 1 is a diagram showing the configuration of an embodiment of a project-data creation apparatus according to the present invention. The project-data creation apparatus in the embodiment is realized on a computer 500 by software processing performed by the computer 500 executing a program (a programming tool). The computer 500 includes a CPU 100, a RAM (Random Access Memory) 40, a data storing unit 401, a display unit 201, a user interface 202, and an external storage medium 301.

The CPU 100 executes a program using the RAM 40 as a work area. The RAM 40 is a storage device that the CPU 100 uses as the work area when executing the program. The display unit 201 is a device that visually displays information. In general, an LCD (Liquid Crystal Display), a CRT (Cathode Ray Tube), or the like is used as the display unit 201. A keyboard and various pointing devices (a mouse, a trackball, a graphic tablet, and the like) are used as the user interface 202. The data storing unit 401 and the external storage medium 301 are storage devices that are incorporated in or externally attached to the computer 500 and store information in a nonvolatile manner. In general, a hard disk drive (HDD), a flash memory drive (flash Solid State Drive: flash SSD), or the like is used as the data storing unit 401 and the external storage medium 301. Note that the external storage medium 301 and the data storing unit 401 can be configured by logically dividing a region of one storage device. The external storage medium 301 stores project data 302, sample data 303, and template data 304. The project data 302 is previously-created project data (existing project data). The sample data 303 is project data simulatively set and provided by a manufacturer to realize a specific function. The template data 304 is partial project data (a template) created by a manufacturer of a programming tool.

The CPU 100 executes a programming tool, which is a project-data creation program, whereby a control unit 101, a data input unit 102, a resource-data managing unit 103, a screen configuring unit 104, a consistency checking unit 105, and a data output unit 106 are formed in the CPU 100.

The control unit 101 controls overall processing concerning the creation of project data. For example, the control unit 101 causes the display unit 201 to display a screen-transition-diagram creation screen.

The data input unit 102 includes a project-data decomposing unit 102a and an import-data decomposing unit 102b. The project-data decomposing unit 102a performs processing for decomposing project data, which a screen designer is creating with operations via the user interface 202, into resources (components and screens to be used and settings concerning the components and the screens, settings common in the entire project, and the like), which are management units in the project data, and outputting information for specifying the resources (identification information) and actual data (object-image data, text-character-string data, and the like) to the resource-data managing unit 103 via the control unit 101. The components here are objects, texts, alarms, and the like. The import-data decomposing unit 102b performs processing for decomposing the sample data, the template data, or the existing project data read out from the external storage medium 301 into resources and outputting the identification information and the actual data to the consistency checking unit 105.

The resource-data managing unit 103 manages index information 103a concerning the resources and records actual data 401a of the resources in the data storing unit 401.

The screen configuring unit 104 manages screen configuration information 104a for defining transition relations of screens and blocks, block information 104b for defining transition relations among screens configuring a block, and belonging block information 104c for defining screens belonging to blocks. Note that the block is equivalent to a case for grouping one or more resources and is a concept similar to a folder in a computer system.

The consistency checking unit 105 determines whether there is redundancy among resources in a project as a whole.

The data output unit 106 converts at least a part of the project into a project format and outputs the part of the project as a file.

When the consistency checking unit 105 determines that redundancy among the resources does not occur, the resource-data managing unit 103 and the screen configuring unit 104 perform, with respective functions thereof, the operation of an import-data integrating unit 107 that integrates data imported into blocks with project data being created.

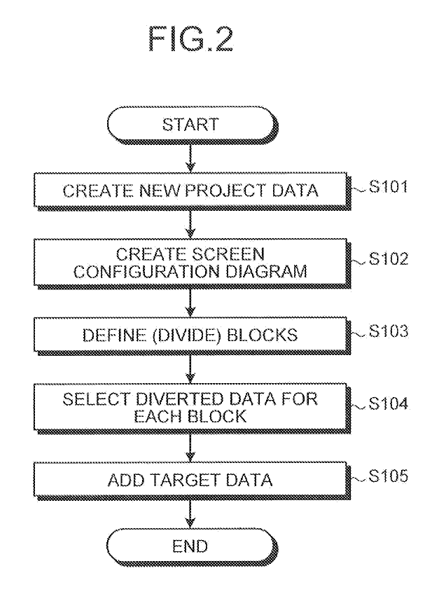

The operation of the project-data creation apparatus according to the embodiment is explained here. FIG. 2 is a flowchart illustrating the flow of import processing performed by the project-data creation apparatus according to the embodiment.

On the editor screen that the control unit 101 causes the display unit 201 to display, the screen designer performs an operation for creating project data via the user interface 202 (step S101). The project-data decomposing unit 102a decomposes the project data created by the operation of the screen designer via the user interface 202 into resources. The project-data decomposing unit 102a outputs identification information and actual data of the decomposed resources to the resource-data managing unit 103 via the control unit 101. The resource-data managing unit 103 generates, on the basis of the identification information on the resources passed from the project-data decomposing unit 102a via the control unit 101, information for managing resources of each screen (index information 103a) and registers and defines the resources input from the project-data decomposing unit 102a. The resource-data managing unit 103 causes the data storing unit 401 to store the actual data of the resources registered and defined in the index information 103a.

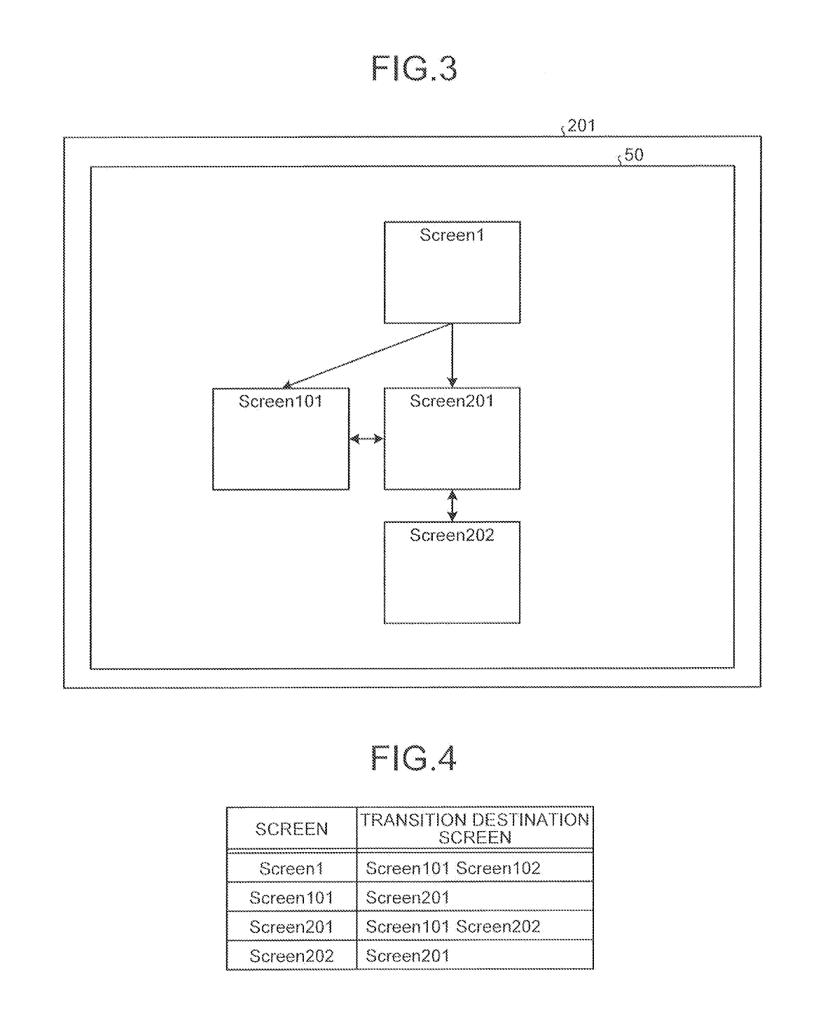

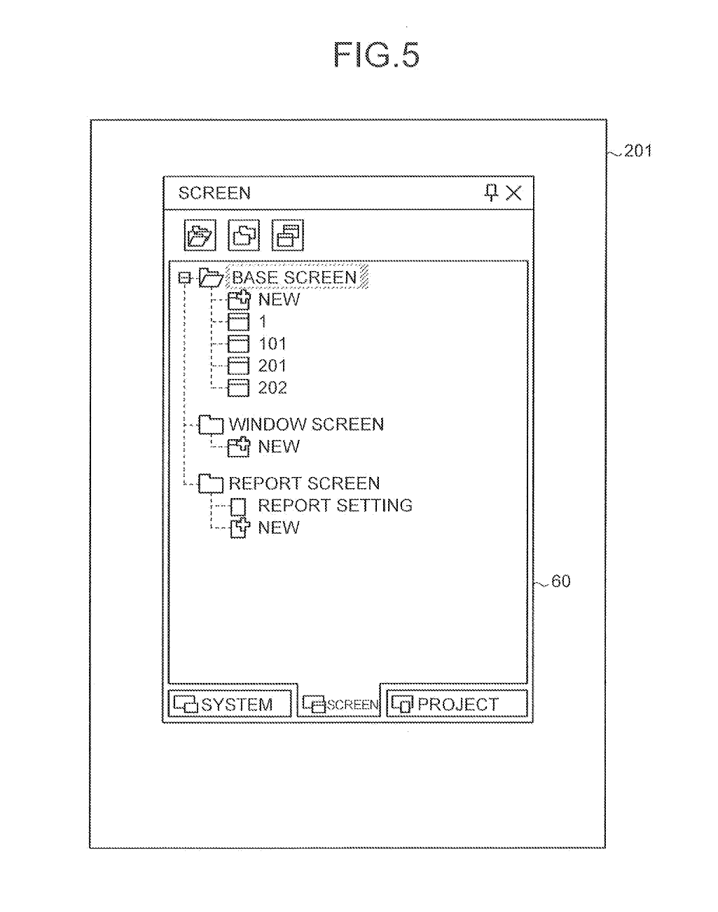

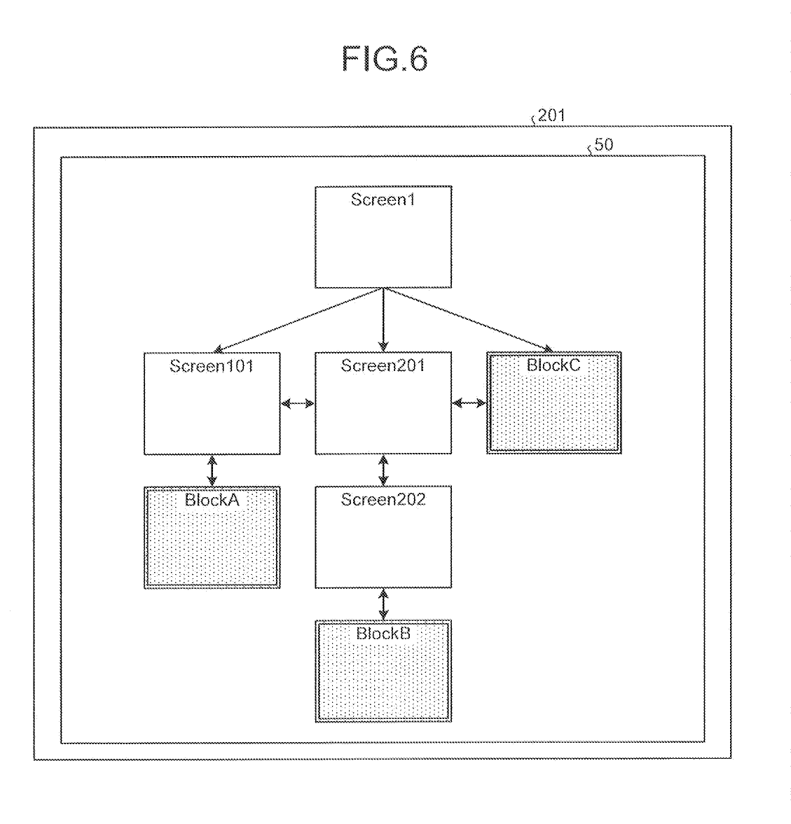

The screen designer performs, on a screen-transition-diagram creation screen 50 that the control unit 101 causes the display unit 201 to display, an operation for creating a screen transition diagram via the user interface 202, whereby the screen configuration information is input to the control unit 101 (step S102). The control unit 101 captures the input screen configuration information and outputs the screen configuration information to the screen configuring unit 104. FIG. 3 is a diagram showing an example of the screen transition diagram. FIG. 4 is a diagram showing an example of the screen configuration information. Note that, in the following explanation, as an example, the operation for inputting the screen configuration information is performed on the screen-transition-diagram creation screen 50. However, the operation for inputting the screen configuration information can also be performed in a similar manner on a creation screen 60 for a screen tree. FIG. 5 is a diagram showing an example of the screen tree. The screen configuration information is information in which information for specifying screens in the screen transition diagram (names, numbers, and the like of the screens) and information for specifying transition destination screens are associated with each other. The screen configuring unit 104 retains and manages the screen configuration information passed from the control unit 101.

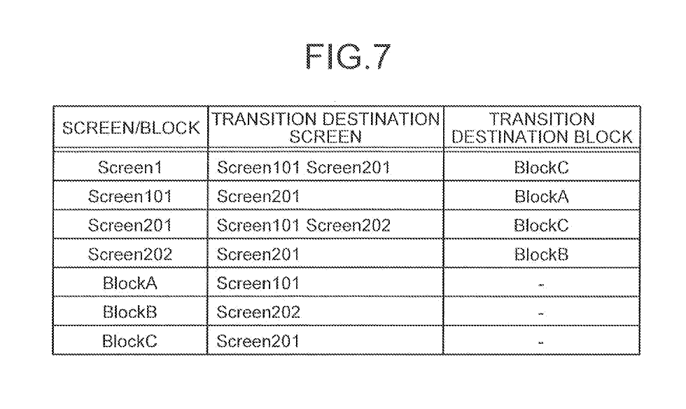

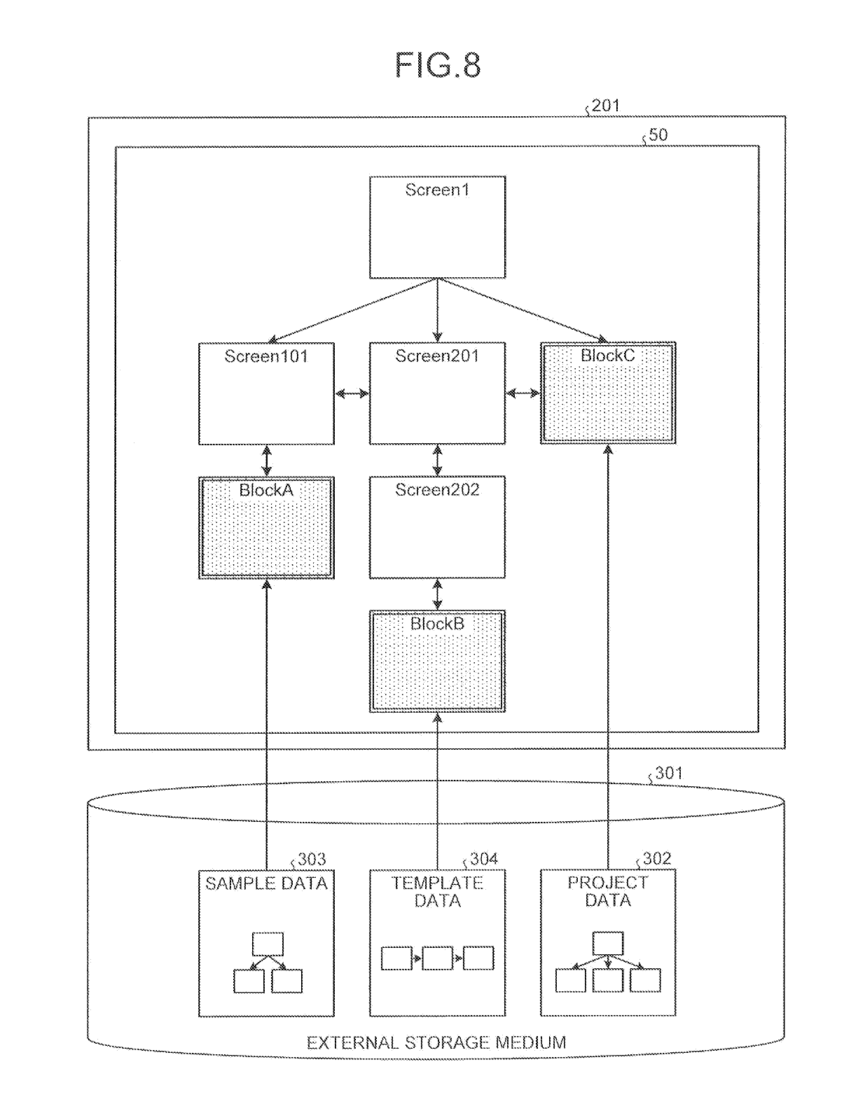

When an operation for defining a block (in other words, an operation for designating which block has a transition relation with which screen in the screen transition diagram) is performed by the screen designer on the screen-transition-diagram creation screen 50 via the user interface 202, the control unit 101 captures input information and outputs the information to the screen configuring unit 104 (step S103). The screen configuring unit 104 changes the screen configuration information on the basis of the information input from the control unit 101 to thereby generate screen configuration information for defining transition relations of screens and blocks included in project data being created. FIG. 6 is a diagram showing an example of the screen transition diagram after the block definition. FIG. 7 is a diagram showing an example of the screen configuration information after the block definition. As shown in FIG. 7, information concerning the transition relation concerning the defined blocks is added to the screen configuration information. The screen configuration information changes to information in which information for specifying the screens and the blocks and information for specifying transition destination screens and blocks are associated with each other.

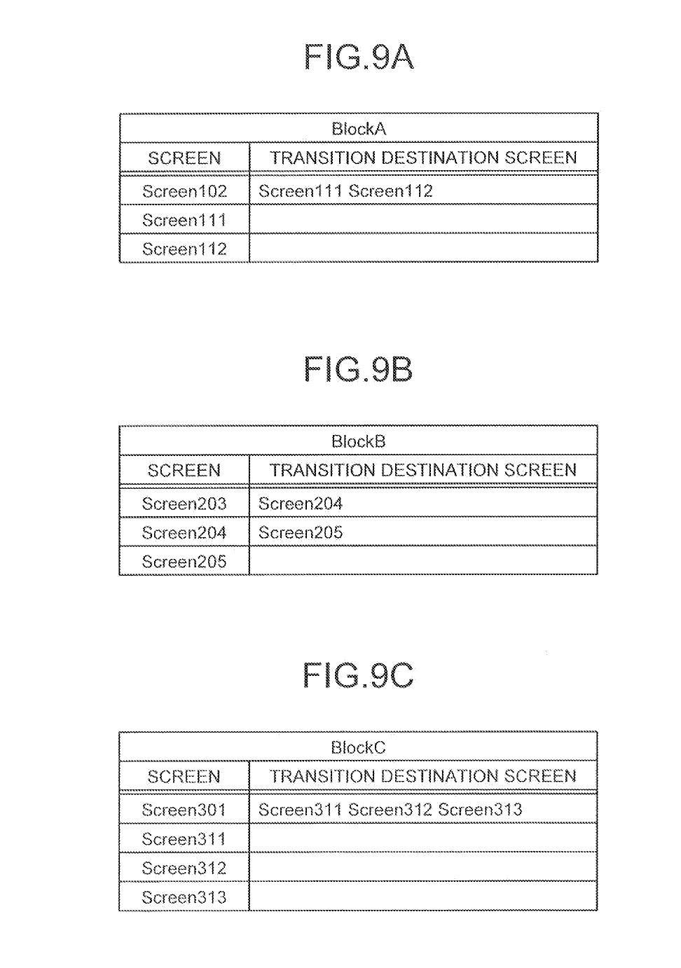

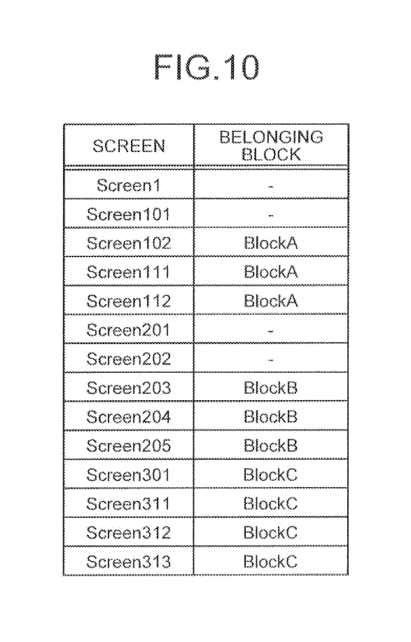

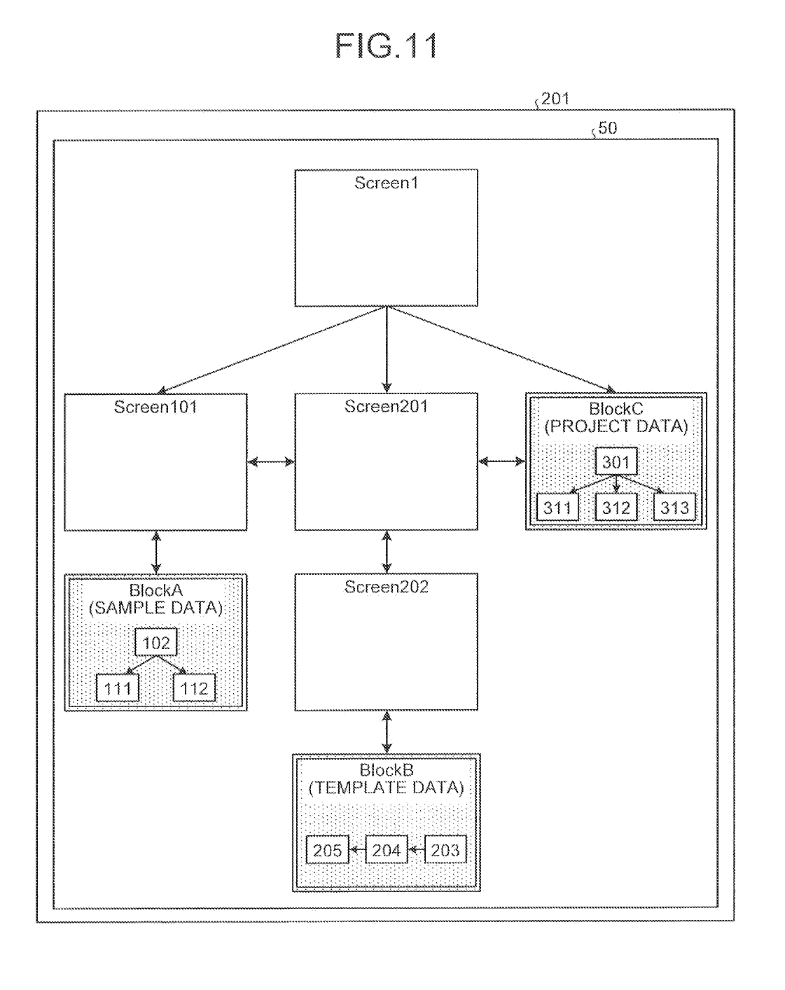

FIG. 8 is a diagram showing the concept of an operation for designating data to be imported into each block. Data that can be imported into each block is the project data 302, the sample data 303, and the template data 304 stored in the external storage medium 301. When an operation for designating data to be imported into each block is performed by the screen designer via the user interface 202 (step S104), the screen configuring unit 104 creates block information 104b indicating information for specifying screens to be imported into the blocks and the transition relations among the import target screens. The screen configuring unit 104 creates belonging block information 104c indicating which screen belongs to which block. The block information 104b and the belonging block information 104c are managed by the screen configuring unit 104. FIG. 9A to FIG. 9C are diagrams showing examples of the block information. The block information is information in which information for specifying the screens configuring the blocks and information for specifying transition destination screens in the blocks are associated with each other. FIG. 10 is a diagram showing an example of the belonging block information.

Thereafter, the control unit 101 sends an instruction to the data input unit 102 and causes the data input unit 102 to read out, from the external storage medium 301, data to be imported into the blocks. The data input unit 102 reads out not only data of screens but also data of associated resources (e.g., settings concerning objects, texts, alarms, and the like to be used) from the external storage medium 301. The import-data decomposing unit 102b decomposes the data read out from the external storage medium 301 into resource units and passes the data to the consistency checking unit 105. Note that the data to be imported into the blocks can also be read out from an external storage device (a memory card or the like) that is not shown and is connected to the computer 500.

The “associated resource” is supplementarily explained with reference to a specific example. When a screen on which an object for performing an alarm display is disposed is imported, it is necessary to simultaneously import the setting of “alarm monitoring”, which is a setting item for a project as a whole concerning what kind of error is displayed in what kind of state. The setting that needs to be performed for an entire project in relation to the object included in the screen or the like to be imported is an associated resource. In a relation in which a screen A displays, as a part of the screen A, another screen B with a screen invoking function, the screen B is a resource associated with the screen A.

The consistency checking unit 105 checks whether a redundant resource is present among the resources passed from the import-data decomposing unit 102b and between the resources passed from the import-data decomposing unit 102b and the resources managed by the resource-data managing unit 103 (resources of project data being created). When a redundant resource is present, the consistency checking unit 105 notifies the control unit 101 that there is redundancy among the resources.

When there is no redundancy among the resources, the consistency checking unit 105 outputs identification information and actual data of the resources input from the import-data decomposing unit 102b to the resource-data managing unit 103. When receiving the identification information and the actual data from the consistency checking unit 105, the resource-data managing unit 103 configuring a part of the import-data integrating unit 107 causes the data storing unit 401 to store the actual data of the resources and manages the actual data. The resource-data managing unit 103 updates index information on the managed resources on the basis of the identification information (step S105). The screen configuring unit 104 forming a part of the import-data integrating unit 107 rebuilds the screen configuration information on the basis of the transition relation among the screens included in the data imported into the blocks and the screen configuration information. In this way, the import-data integrating unit 107 integrates the data imported into the blocks with the project data being created.

Note that processing for importing existing data into the blocks is explained in detail hereinafter with reference to a specific example.

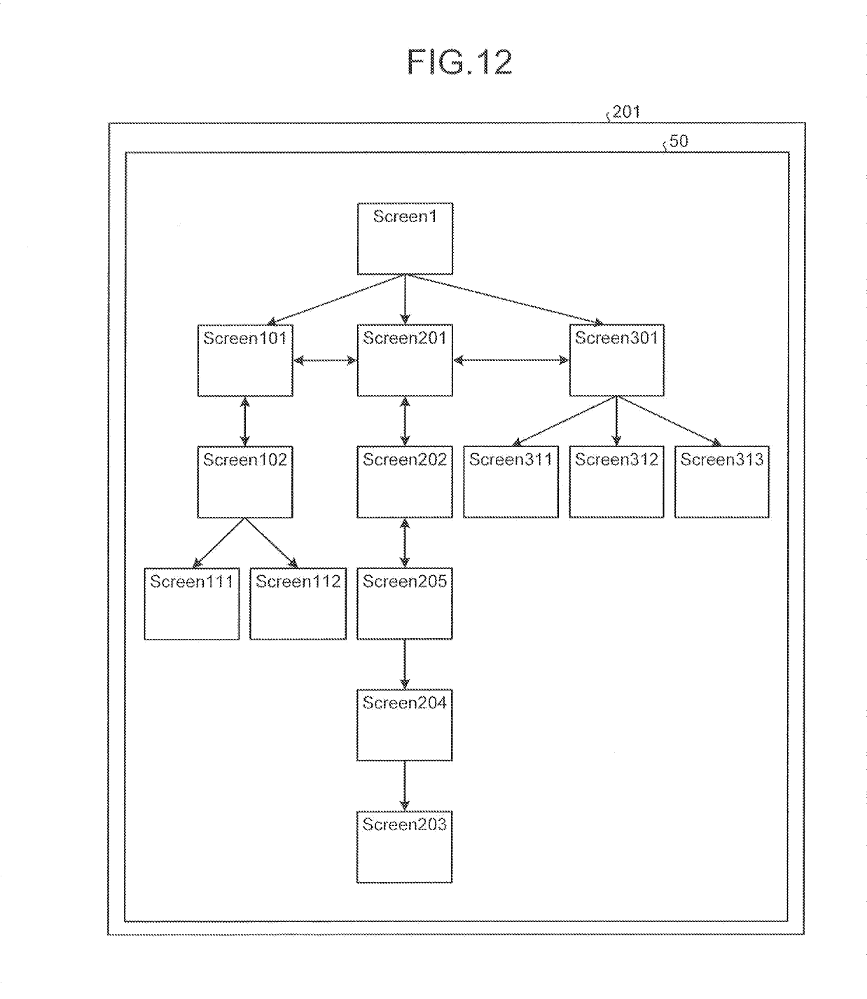

FIG. 11 is a diagram showing an example of the screen transition diagram after the import processing.

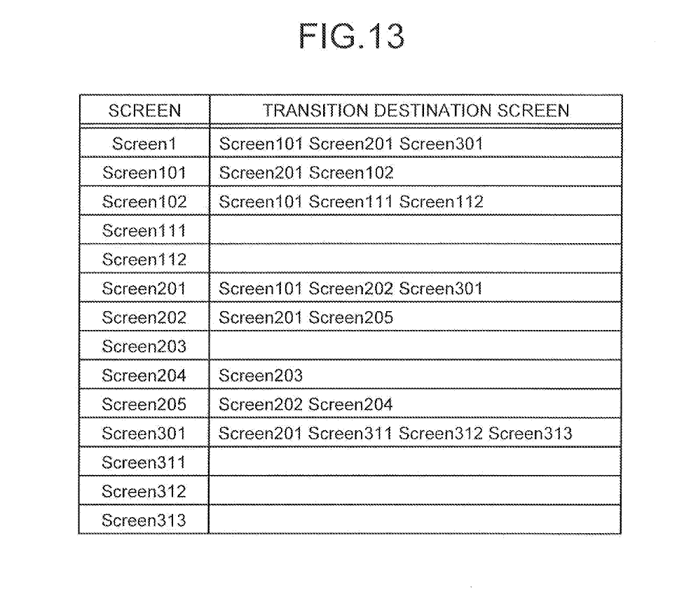

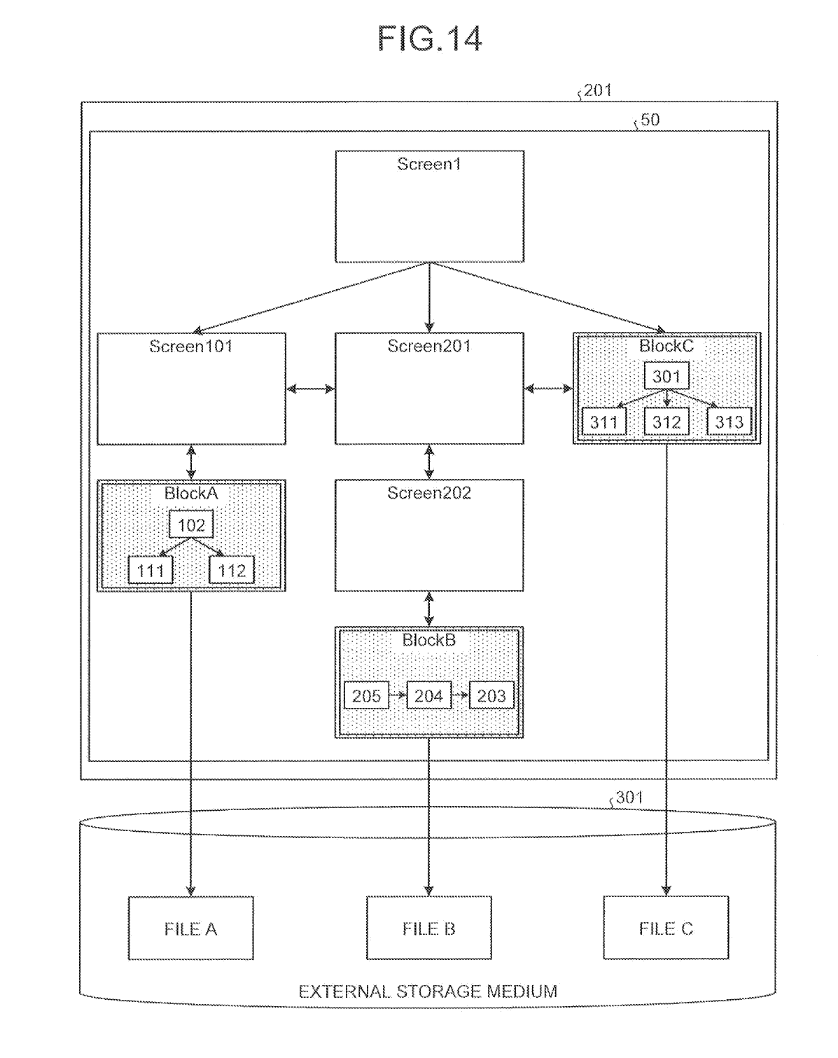

After the completion of the import processing, it is possible to expand the blocks. The expansion of the blocks can be automatically performed by the control unit 101 after the import processing or can be performed by being triggered by a specific operation via the user interface 202. When a plurality of screens are included in a block, a transition destination from a screen including the block as a transition destination screen can be determined on the basis of a predetermined rule or can be designated by prompting a user to input the transition destination. For example, a screen having the smallest screen number among the screens included in the block can be selected as the transition destination. When the blocks are expanded, the screen configuring unit 104 updates the screen configuration information. FIG. 12 is a diagram showing an example of the screen transition diagram after the expansion of the blocks. FIG. 13 is a diagram showing an example of the screen configuration information after the expansion of the blocks. When the blocks are expanded, the items of the blocks in the screen configuration information before the expansion (i.e., the screen configuration information after the block definition shown in FIG. 7) are updated on the basis of the content of the block information 104b. Note that, even after the blocks are expanded, the screen configuring unit 104 retains the block information 104b and the belonging block information 104c without erasing them. Therefore, as explained below, it is also possible to re-block the expanded blocks.

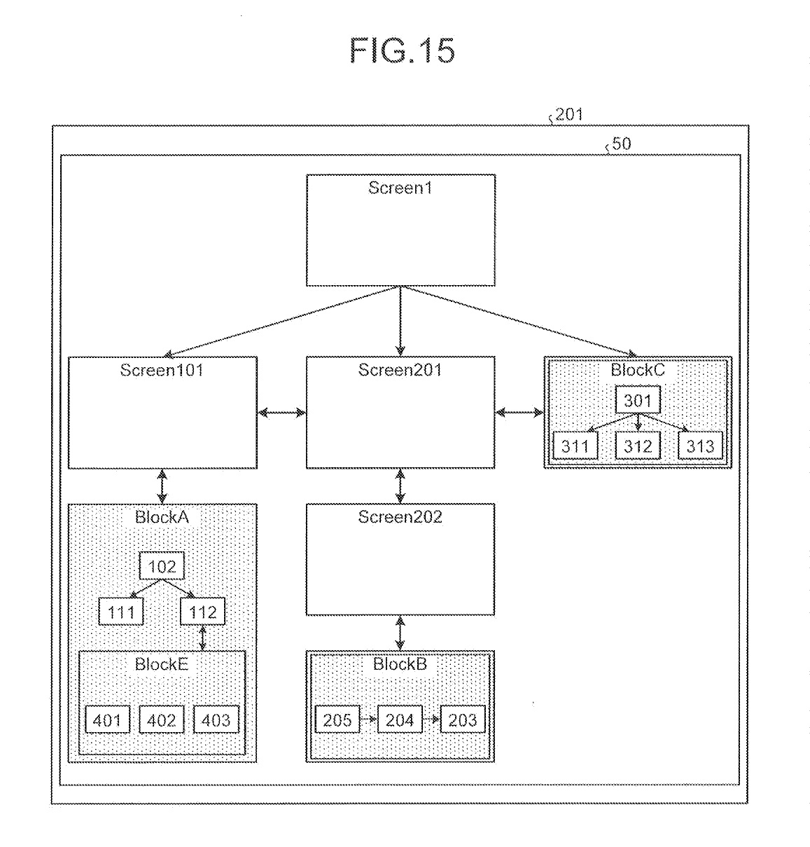

The resources such as the screens included in each block, i.e., data grouped by a block can also be stored as one file for each block. When the screens included in a block are stored as one file, the resource-data managing unit 103 reads out, according to a command from the control unit 101, necessary data (actual data and data of associated resources) from the data storing unit 401 on the basis of the belonging block information 104c defined by the screen configuring unit 104 and the index information on the resources managed by the resource-data managing unit 103. The data read out by the resource-data managing unit 103 is converted into a form of one project by the data output unit 106 and output to the external storage medium 301 as a file. The data can be stored in the external storage medium 301 in any storage form such as storage under another name or export. FIG. 14 is a conceptual diagram in which data is stored as one file for each block.

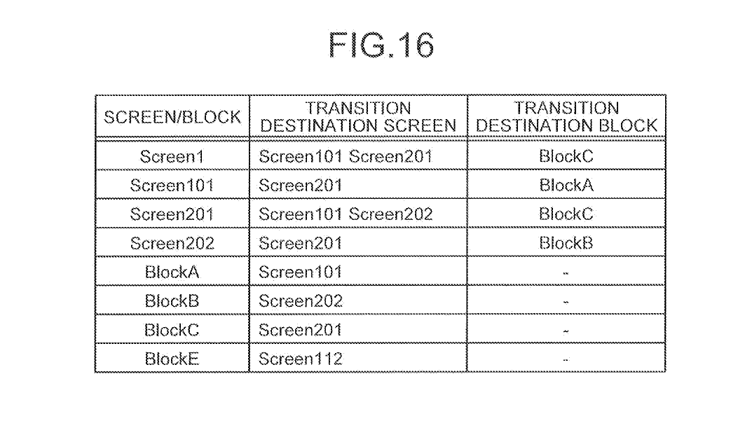

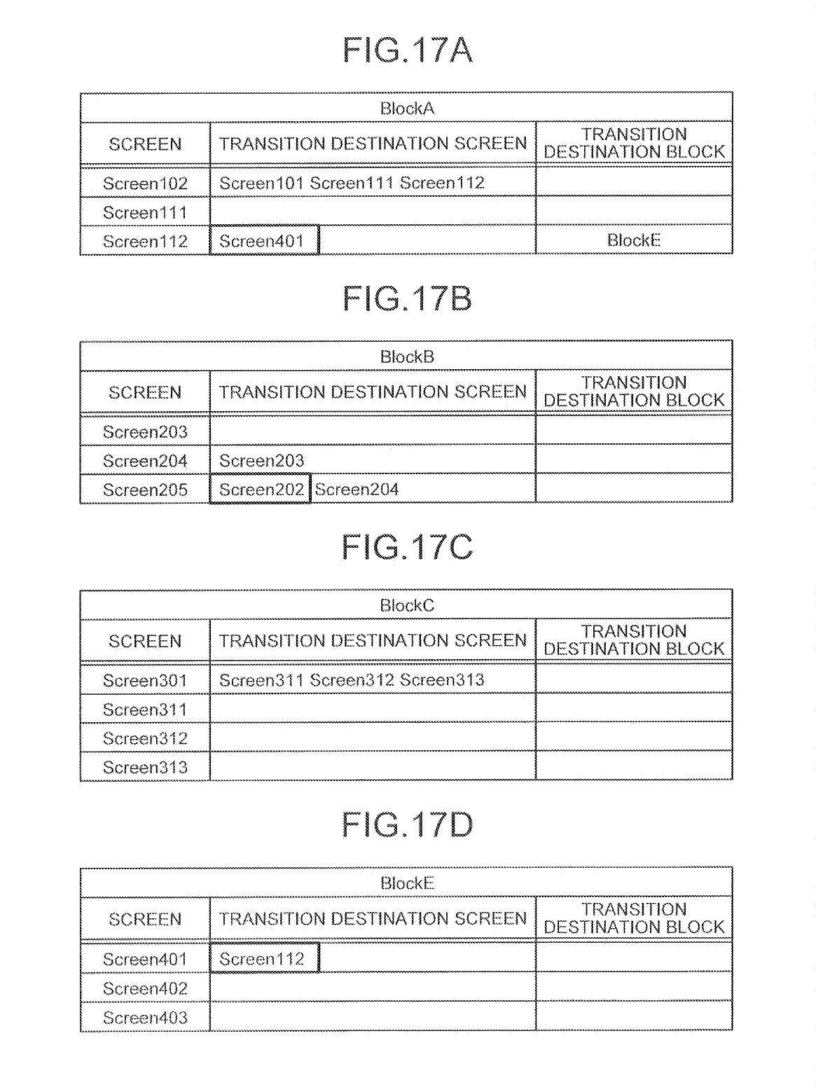

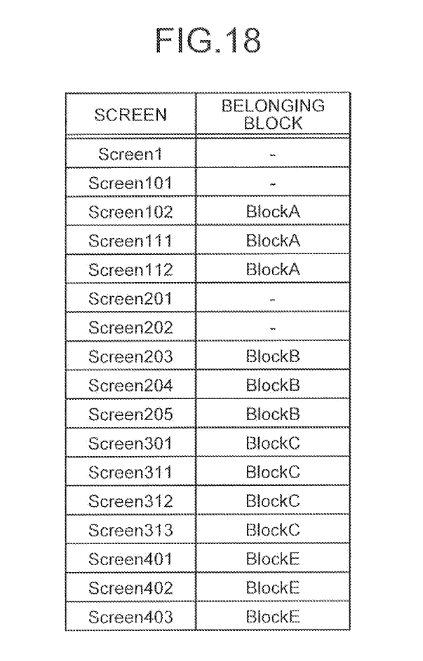

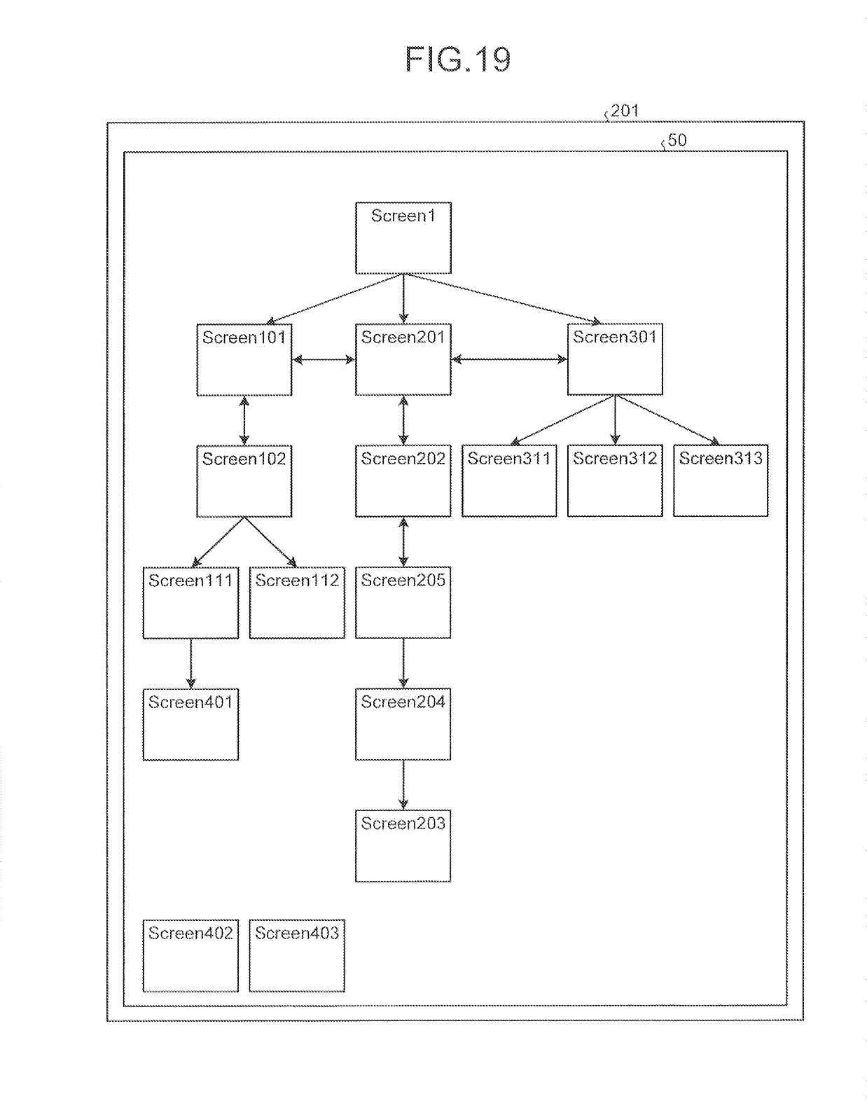

A new block can also be defined or imported after the completion of the import processing. FIG. 15 is a diagram showing a screen transition diagram in which another block (a block E) is defined in or imported into a block A after the completion of the import processing. FIG. 16 is a diagram showing an example of the screen configuration information after the definition or the import of the block E. FIG. 17A to FIG. 17D are diagrams showing examples of the block information. FIG. 18 is a diagram showing the belonging block information after the definition or the import of the block E. Note that, in FIG. 16 and FIG. 17A to FIG. 17D, mutual transition between the screen with a screen number 112 and the block E, mutual transition between the screen with a screen number 202 and the screen with a screen number 205, transition from the screen with a screen number 1 to the screen with a screen number 301, and transition from the screen with a screen number 201 to the screen with the screen number 301 are added by an operation performed by the user via the user interface 202.

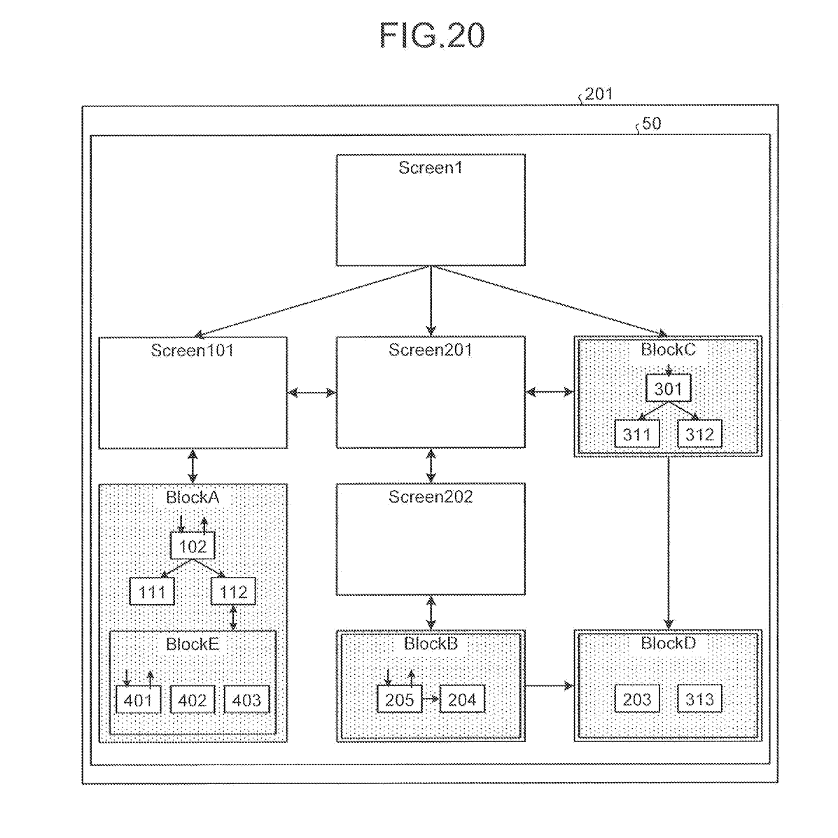

FIG. 19 is a diagram showing a screen transition diagram in which the blocks A to C and E are expanded. It is defined in the screen configuration information that the screen with a screen number 101 and the block A are in a relation of mutual transition. Therefore, mutual transition with the screen with the screen number 101 is set in the screen with a screen number 102, which is the smallest screen number among the screens included in the block A. Note that the user can set to which screen in a block transition is added in advance as a rule or on each occasion.

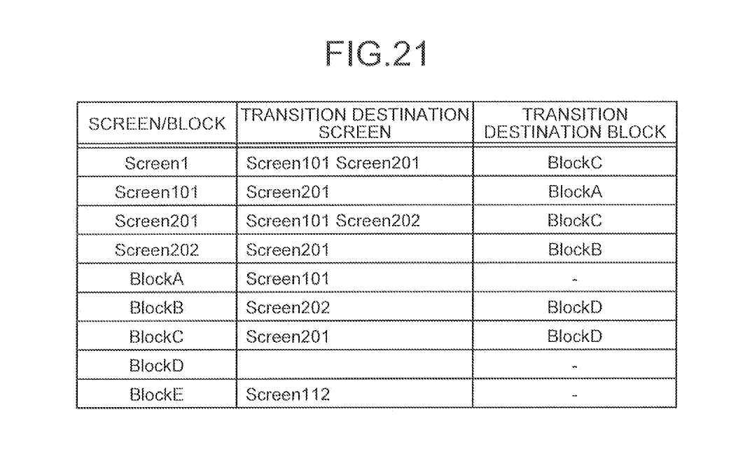

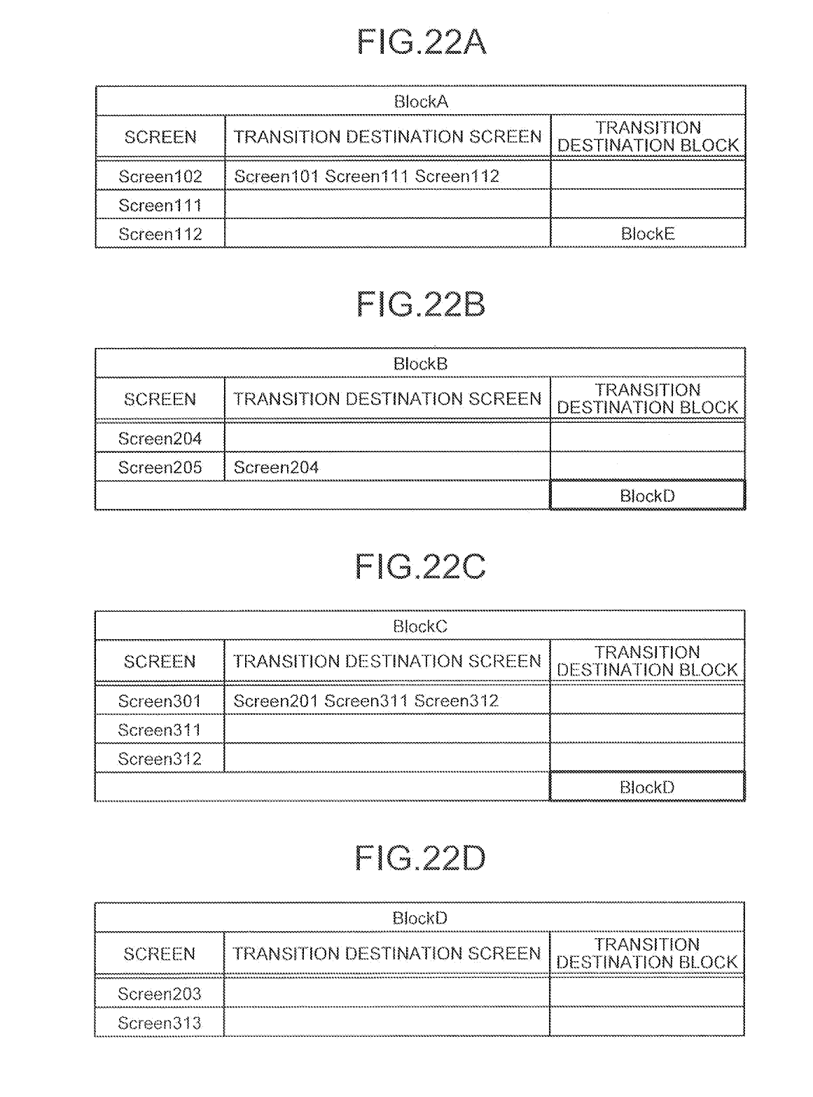

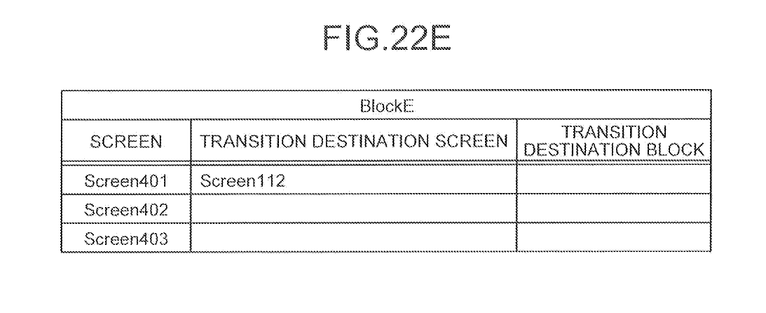

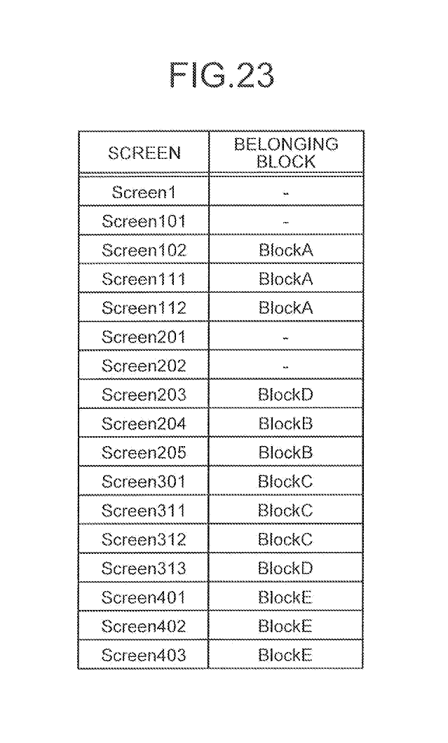

It is assumed that the screen with a screen number 203 and the screen with a screen number 313 having no transition relation are blocked as a block D and the blocks A to C and E are re-blocked. FIG. 20 is a diagram showing a screen transition diagram in which the screen with the screen number 203 and the screen with the screen number 313 are defined as the block D. FIG. 21 is a diagram showing screen configuration information in which the screen with the screen number 203 and the screen with the screen number 313 are defined as the block D. FIG. 22A to FIG. 22E are diagrams showing examples of the block information. FIG. 23 is a diagram showing belonging block information in which the screen with the screen number 203 and the screen with the screen number 313 are defined as the block D. Each screen can belong to only one block. Therefore, the screen configuring unit 104 changes the block to which the screen with the screen number 203 belongs from B to D and changes the block to which the screen with the screen number 313 belongs from C to D. Because the screen with the screen number 203 is in a different block from the block B, the screen configuring unit 104 deletes designation of the screen with the screen number 203 as a transition destination from the screen with a screen number 204. Similarly, because the screen with the screen number 313 is in a different block from the block C, the screen configuring unit 104 deletes designation of the screen with the screen number 313 as a transition destination from the screen with the screen number 301.

As explained above, even after the blocks are expanded, the screen configuring unit 104 retains the belonging block information 104b and the block information 104c without erasing them. Consequently, it is possible to perform re-blocking. Note that, in an example explained here, the new block D is defined and then the screens are re-blocked. However, it is obvious that the screens can be blocked to the original state.

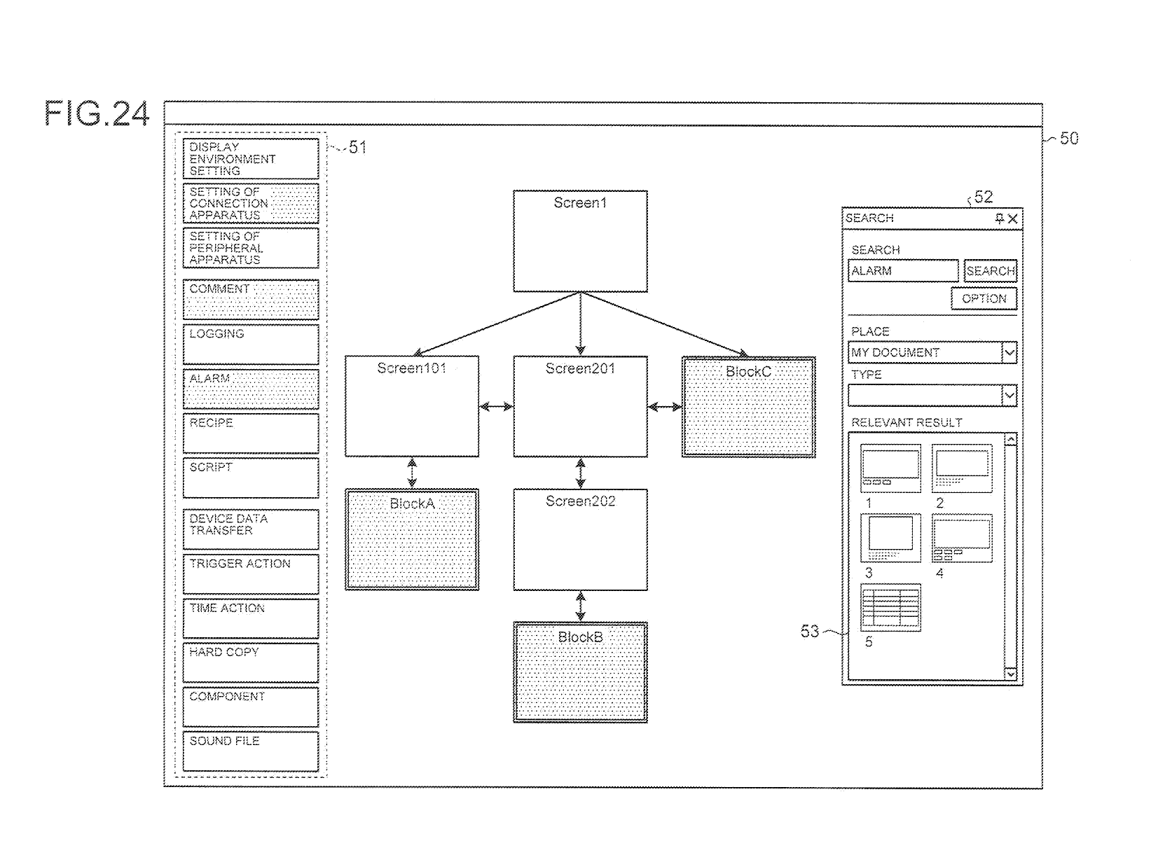

A specific example of processing for importing existing data into a block is explained here. FIG. 24 is a diagram showing an example of the screen-transition-diagram creation screen. The control unit 101 displays a resource-setting display field 51 in the screen-transition-diagram creation screen 50. In the resource-setting display field 51, items set in a project being created are displayed in a form (in FIG. 24, in a hatched state) different from items not set in the project. Note that, if the display unit 201 is capable of performing color display, the display color can be varied.

A search screen 52 can be invoked from the screen-transition-diagram creation screen 50. When an operation for invoking the search screen 52 is performed via the user interface 202, the control unit 101 displays the search screen 52 in the screen-transition-diagram creation screen 50. From the search screen 52, it is possible to search for one screen or a plurality of screens, an existing project, a template, and the like. By dragging a search result displayed in a search-result display field 53 of the search screen 52 and dropping the search result in a block of the screen transition diagram, it is possible to designate the dragged and dropped data as data to be imported into the block. Note that the operation for designating data to be imported into the block is not limited to the drag & drop. It is also possible to apply, for example, an operation (touch & touch) for touching the search result displayed in the search-result display field 53 and subsequently touching the block in the screen transition diagram.

Note that, in searching for data such as screens, it is also possible that setting information for specifying respective data recorded in the external storage device 301 is recorded in association with at least any one of a plurality of keywords for each data; criteria data indicating the difficulty set in respective kinds of operations of a programming tool is recorded; and user data indicating the execution environment of the programming tool and the operation content applied to the input interface 202 by the user is accumulated. Then, setting information associated with a keyword coinciding with the term input from the input interface 202 is detected. The user's proficiency and preference are determined on the basis of the criteria data and the user data. The setting information is ranked on the basis of the determination result of a character determining unit and displayed in the search-result display field 53. Then, it is possible to quickly find screen data and template data matching the purpose of the user and efficiently present the content corresponding to the user's proficiency and preference.

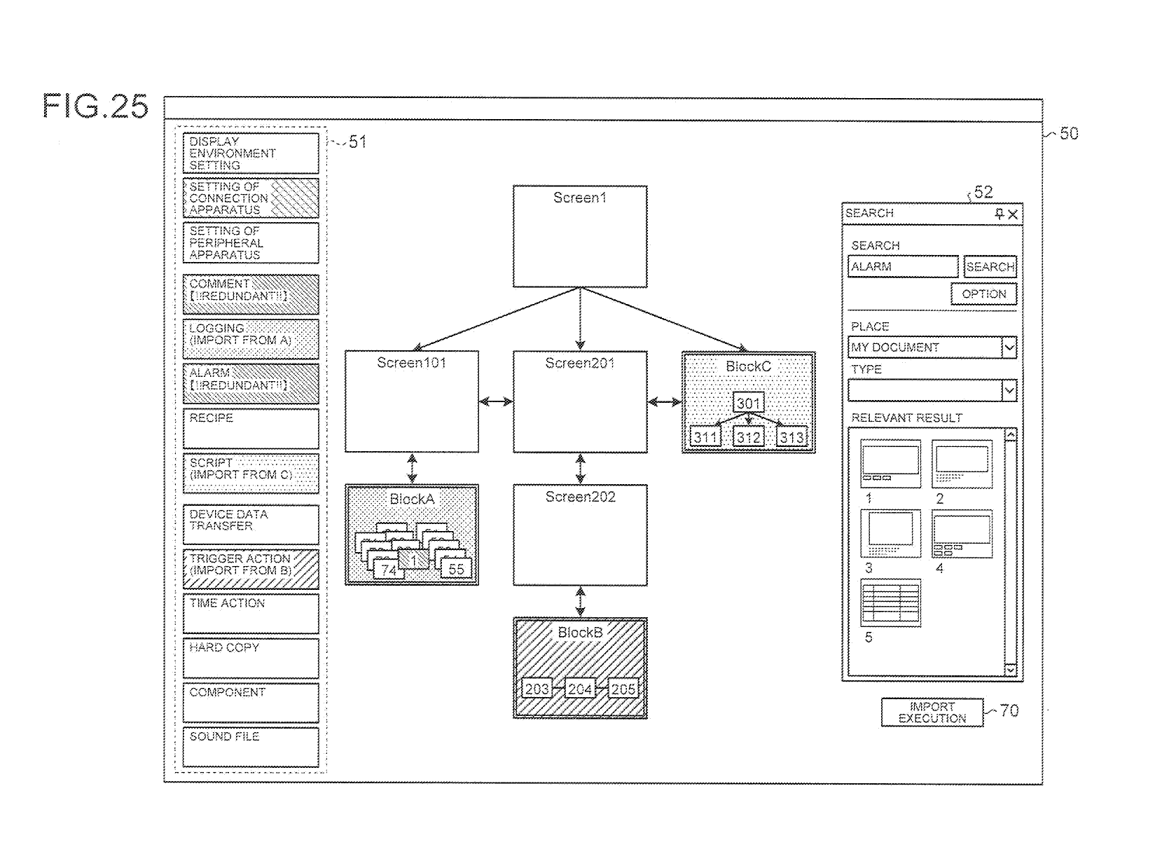

When resource data is imported, the control unit 101 displays, in the resource-setting display field 51, a message indicating the import source. When there is redundancy among resources of the imported data or between resources set in a project being created and the resources of the imported data, the control unit 101 displays, in the resource-setting display field 51, a warning to the effect that there is redundancy among the resources. FIG. 25 is a diagram showing a screen-transition-diagram creation screen in which a warning to the effect that there is redundancy among resources is displayed in the resource-setting display field. In the screen-transition-diagram creation screen 50, the blocks are displayed in different colors. In the resource-setting display field 51, a resource planned to be imported is displayed in the color same as the color of a block of the import source. Consequently, it is possible to easily distinguish, on the screen-transition-diagram creation screen 50, into which block a resource is imported. Note that, in FIG. 25, the types of hatching are changed to represent that the colors of the blocks and the like are different from each other.

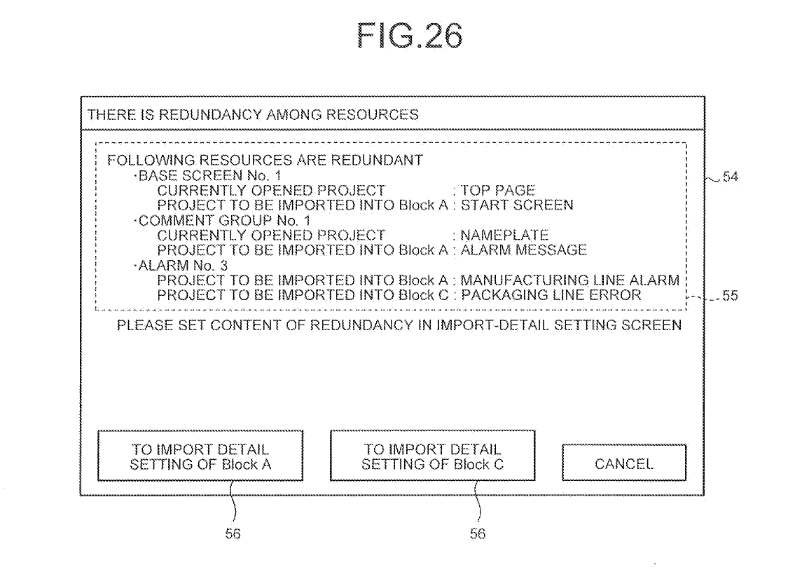

When a specific operation (selection, double click, or the like in a menu displayed by a right click) is applied to the item for which a warning is displayed, the control unit 101 causes the display unit 201 to display a redundant-content check screen 54. When an import execution button 70 is pressed in a state in which the warning display is performed, the control unit 101 also causes the display unit 201 to display the redundant-content check screen 54. FIG. 26 is a diagram showing an example of the redundant-content check screen. The redundant-content check screen 54 includes a redundant-content display field 55 and an import-detail-setting invoking button 56. The redundant-content display field 55 indicates which portions of resources are redundant. When the import-detail-setting invoking button 56 is pressed, the control unit 101 causes the display unit 201 to display an import-detail setting screen 57. Note that, when a specific operation (selection, double click, or the like in a menu displayed by a right click) is performed on a block of the screen transition diagram, the control unit 101 also causes the display unit 201 to display the import-detail setting screen 57.

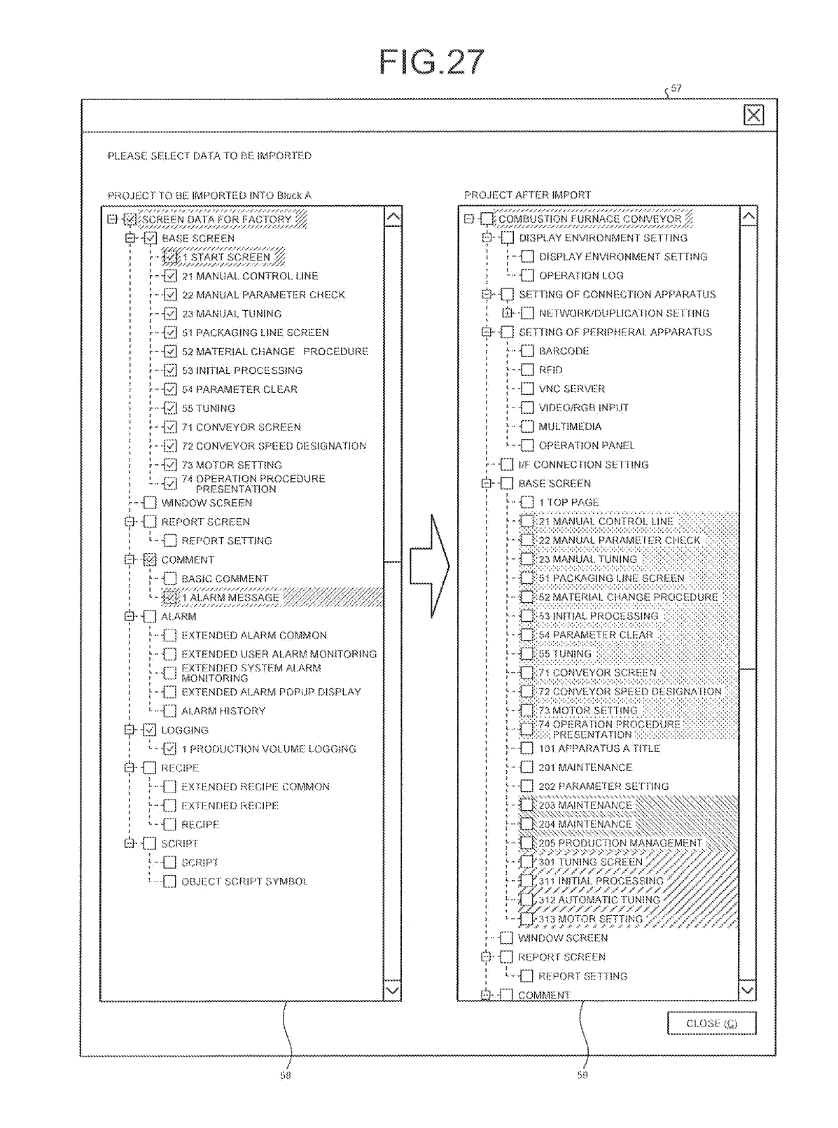

FIG. 27 is a diagram showing an example of the import-detail setting screen. An import-item selection field 58 on the left side of the import-detail setting screen 57 is an operation field for selecting resources to be imported into blocks. In FIG. 27, the resources with check marks in boxes are imported into blocks. The items displayed in the redundant-content display field 55 of the redundant-content check screen 54 are displayed in a different background color. Therefore, it is possible to easily distinguish which items are redundant.

A post-import-project display field 59 on the right side of the import-detail setting screen 57 indicates resources of a project after the resources selected in the import-item selection field 58 are imported. In the post-import-project display field 59, resources planned to be imported are displayed in a different background color for each block. Therefore, it is possible to easily distinguish into which block resources are imported. Note that, in FIG. 27, the types of hatching are changed to represent that the background colors are different from each other. In the post-import-project display field 59, it is possible to change screen numbers and titles after the import. For example, by changing “21 manual control line” on a base screen to “111 manual control line”, the resource “manual control line” can be imported with the screen number changed from 21 to 111.

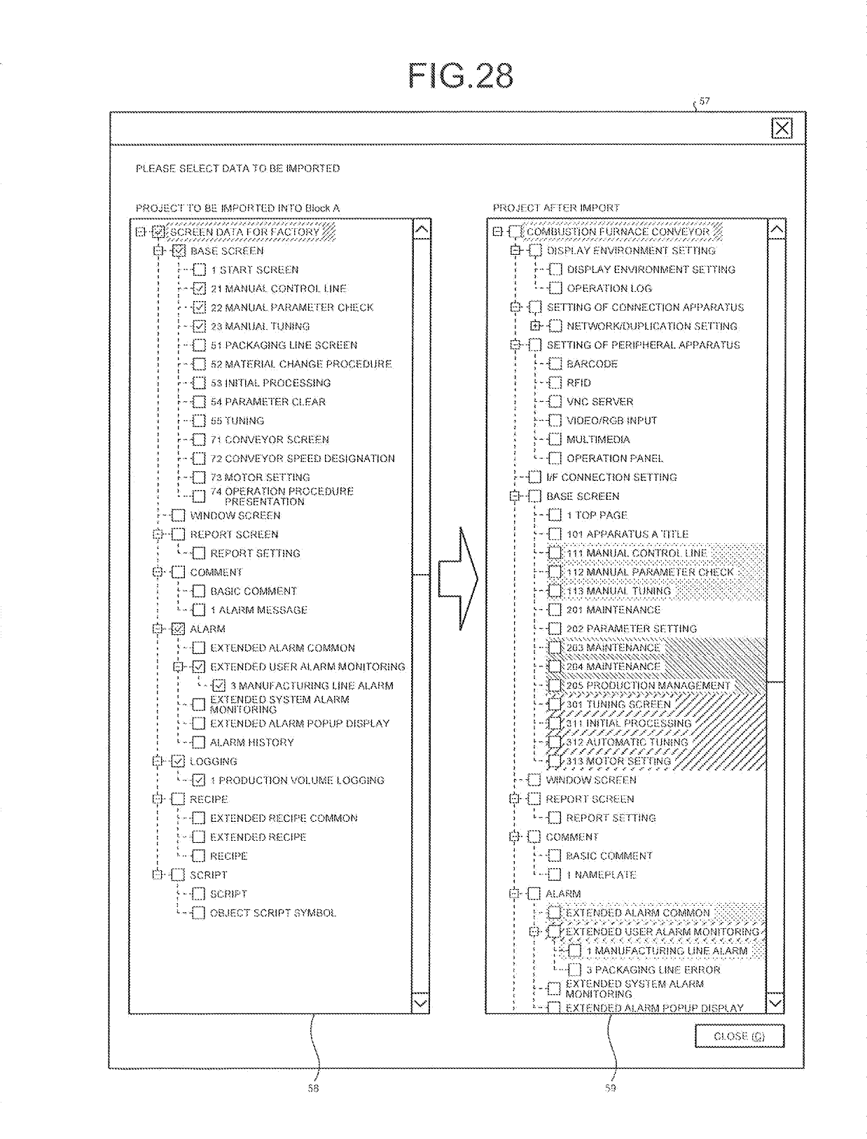

FIG. 28 is a diagram showing an example of the import-detail-setting screen after the resources to be imported are changed. In FIG. 28, as in FIG. 27, the types of hatching are changed to represent that the background colors are different from each other. A check mark in the import-item selection field 58 for “comment group No. 1 alarm message” displayed in the redundant-content display field 55 of the redundant-content check screen 54 is removed. The “comment group No. 1 alarm message” is excluded from the import targets. A number of “alarm No. 3 manufacturing line alarm” is changed from 3 to 1 in the post-import-project display field 59. With these operations, the redundancy among the resources displayed in the redundant-content display field 55 of the redundant-content check screen 54 is eliminated.

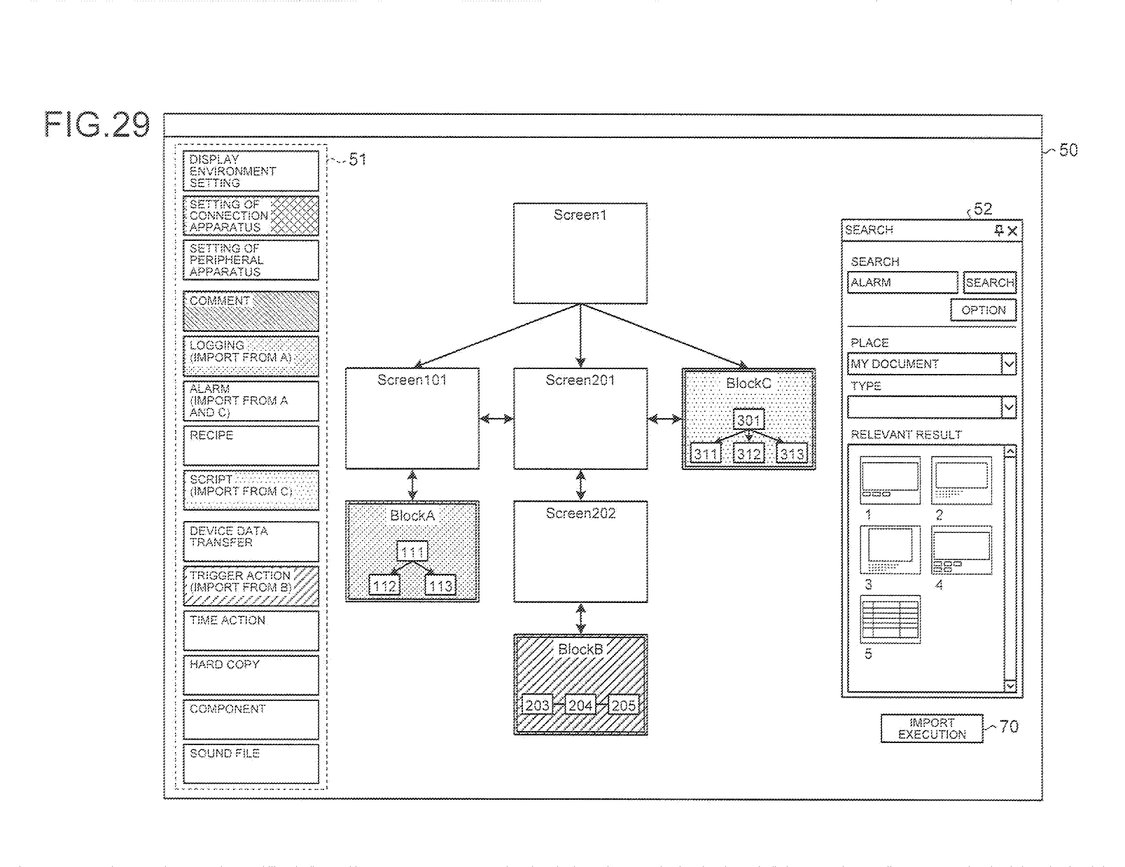

FIG. 29 is a diagram showing a screen-transition-diagram creation screen after the redundancy among the resources is eliminated. In FIG. 29, as in FIG. 25, the types of hatching are changed to represent that the colors of blocks and the like are different from each other. When the import execution button 70 is pressed in this state, data is imported into each block.

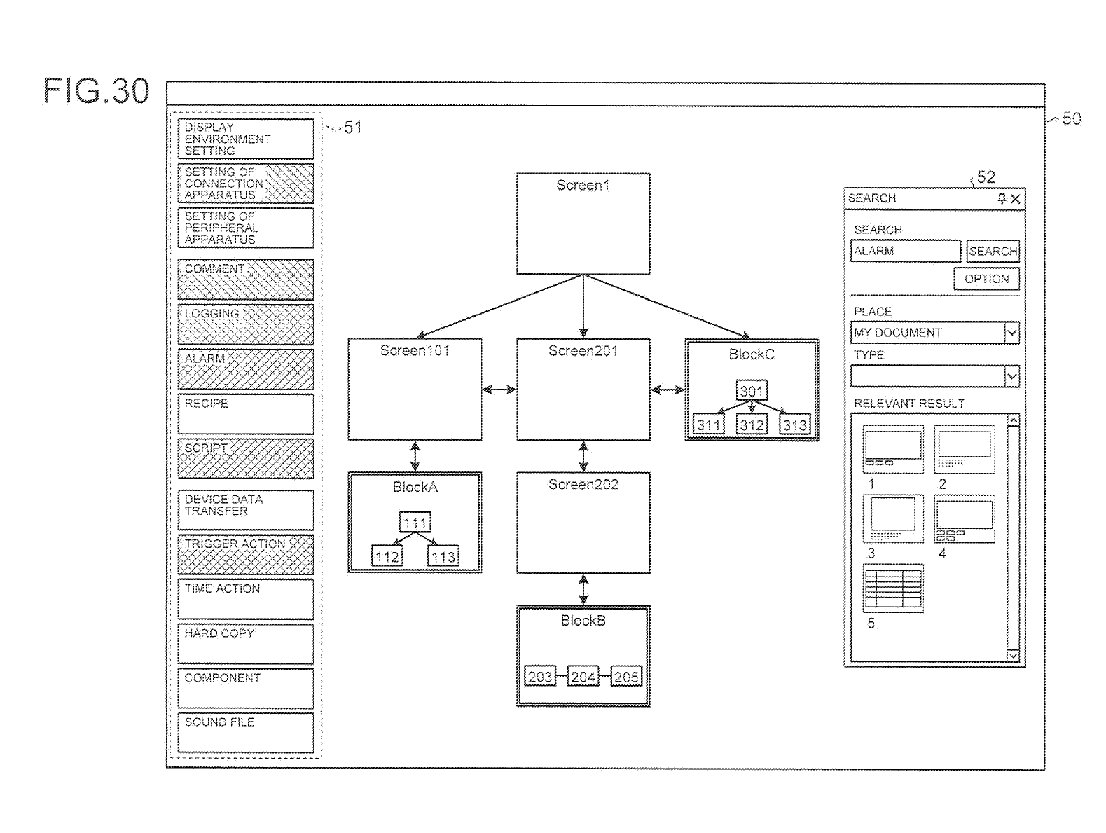

FIG. 30 is a diagram showing a screen-transition-diagram creation screen after the completion of the import. The display indicating into which blocks the resources are imported in the resource-setting display field 51 disappears. The items set in the project are displayed in colors different from that of the items not set in the project. After the completion of the import, it is possible to expand each block as explained above.

The project-data creation apparatus according to the present embodiment can visually perform import from a plurality of pieces of data. For example, an operation for importing screens with screen numbers 1 to 10 and setting of an alarm from the data A, importing screens with screen numbers 50 to 75, setting of connected apparatuses, and setting of logging from the data B, and importing setting of setup of a programmable display from the data C can be performed with a feeling of combining pieces of a puzzle. In other words, the project-data creation apparatus according to the present embodiment can easily perform import from a plurality of pieces of data by adopting a concept of division of project data into blocks and matching the concept with a screen transition diagram and the like.

When a plurality of people correct one project file, data is output in block units, each person corrects the data in a different block, and the data after the completion of the correction is imported into each block to be integrated. Consequently, it is possible for a plurality of people to perform correction work. In the integration, if there is redundancy among resources, an alarm display is performed. Therefore, consistency of project data is not spoiled even if a plurality of people share the work.

As explained above, the project-data creation apparatus according to the present embodiment can create one project by partially diverting data from a plurality of pieces of data. It is possible to divert data including a transition relation among screens. When a plurality of people share the work to create project data, it is easy to integrate the data. It is possible to collectively divert resources (e.g., settings concerning objects, texts, alarms, and the like to be used) associated with screens.

### INDUSTRIAL APPLICABILITY

As explained above, the project-data creation apparatus according to the present invention is useful in that it is possible to create project data by partially diverting previously-created screen data, templates, sample data, and the like. In particular, the project-data creation apparatus is suitable when a plurality of people share the work to create project data.

### REFERENCE SIGNS LIST

40 RAM, 50 screen-transition-diagram creation screen, 60 creation screen for a screen tree, 70 import execution button, 100 CPU, 101 control unit, 102 data input unit, 102a project-data decomposing unit, 102b import-data decomposing unit, 103 resource-data managing unit, 103a index information, 104 screen configuring unit, 104a screen configuration information, 105 consistency checking unit, 106 data output unit, 107 import-data integrating unit, 201 display unit, 202 user interface, 301 external storage medium, 302 project data, 303 sample data, 304 template data, 401 data storing unit, 401a actual data, 500 computer.

1. A project-data creation apparatus that includes a data storing unit and an external storage medium that store information in a nonvolatile manner, and that creates project data including a plurality of screens, the apparatus comprising:
a project-data decomposing unit that decomposes project data being created into resources, which are management units;
a resource-data managing unit that generates index information for managing resources decomposed by the project-data decomposing unit and causes the data storing unit to store actual data of resources;
a screen configuring unit that creates, in the project data being created, one or more blocks each for grouping one or more resources and generates screen configuration information defining a transition relation between screens included in the project data being created and the blocks;
an import-data decomposing unit that reads out, from the external storage medium, data to be imported into each of the blocks and decomposes the data into resources;
a consistency checking unit that determines whether resource redundancy occurs among data to be imported into the blocks and between the project data being created and the data to be imported into the blocks; and
an import-data integrating unit that, when the consistency checking unit determines that resource redundancy does not occur, integrates the data imported into each of the blocks with the project data being created by rebuilding the screen configuration information on a basis of a transition relation among screens included in the data imported into each of the blocks and causing the data storing unit to store actual data of resources of imported data.

2. The project-data creation apparatus according to claim 1, wherein the import-data integrating unit imports, among pieces of data to be imported into the blocks, a resource designated by an operation of a user into the project data being created.

3. The project-data creation apparatus according to claim 2, wherein the import-data integrating unit imports a resource associated with the resource designated by an operation of a user into the project data being created.

4. The project-data creation apparatus according to claim 1, wherein a transition relation between screens included in the project data being created and the blocks is defined on a screen-transition-diagram creation screen or on a screen tree.

5. The project-data creation apparatus according to claim 1, further comprising a data output unit that converts actual data of a resource included in each of the blocks into a project form and outputs the actual data to the external storage medium.
